(19) United States
(12) Patent Application Publication
(10) Pub. No.: US 2010/0087135 A1
(43) Pub. Date: Apr. 8, 2010

(54) METHOD AND THROTTLING DEVICE TO CONTROL AN AIR FLOW IN A CHANNEL OR IN A CHANNEL SYSTEM

(76) Inventor: Goran Bernhardsson, Lidingo (SE)

Correspondence Address: YOUNG & THOMPSON, 209 Madison Street, Suite 500, Alexandria, VA, 22314, US

(21) Appl. No.: 12/530,381

(22) PCT Filed: Mar. 5, 2008
(86) PCT No.: PCT/SE2008/000178

§ 371 Date: Sep. 8, 2009

(30) Foreign Application Priority Data
Mar. 5, 2007 (SE) 0700549-9

(51) Int. Cl. F24F 13/10; F16K 1/20; F24F 13/14

(52) U.S. Cl. 454/319; 454/313

(57) ABSTRACT

A method and a throttling device to control an air flow in a channel (1) or in a channel system. The air flow is brought to pass at least a first channel portion having a successively tapering channel cross section area being formed by a adjustable throttling device (4) in the channel, the air thereafter is led to an other channel portion having a cross section with an increased throttling formed by the adjustable throttling device, to continue flowing in the channel portion with the increased throttling over a distance being considerably longer than the distance between the outer wall of the throttling device and the inner wall of the of the channel portion to thereafter leave the second channel portion with the increased throttling at a third channel portion and be transferred into the not throttled channel.

The present invention relates to a method and a throttling device to control an air flow in a channel or in a channel system. A channel system may form part of a ventilating plant involving several throttling devices, each of which existing in connection to a room or a space which is wanted to have ventilated. The incoming air to each room or space may have to be basically preset adjusted.

The most common and simplest form of a throttling device in a channel is a single leaf damper. Such a leaf damper has a bad control characteristic in that the control curve will be exponential, i.e. the control area will be in a relative close angle of rotation for the damper. Furthermore the turbulence around the edges of the leaf damper will cause disturbing noise.

There are other types of throttling devices based on the same principle, i.e. the drop of pressure is caused by a local increase of the flow velocity and as a loss of the dynamic pressure in the cross section having the high velocity. It is possible that some of these constructions have succeeded to achieve a better control characteristic, but the problem with disturbing noise from the turbulent flow is still there and may even increase.

To avoid the problem with disturbing noise at high pressure drops throttling devices in which the pressure drop is created by friction losses in a number parallel channels having small cross sections creating a laminar flow with a high friction coefficient. Thus, it will then be difficult to control the pressure drop in an other way than by changing inserts of a varying set length.

The object of the present invention is to obtain a throttling device with the characteristic having better control characteristics and a far lower noise level.

This is according to the present invention obtained by a method to control an air flow and throttling device having the characterizing clauses mentioned in the claims.

The throttling device according to the present invention have a good control characteristic and works at a low noise level in that the flow losses at a high degree of throttling, i.e. at a high pressure drop, is mainly friction losses at a laminar flow in a channel or slot with a small height.

By the control characteristic being mainly linear for a throttling device according to the invention it is much easier to pre adjust a channel system with several throttling devices compared to a conventional throttling device of a simple leaf damper character having an exponential control characteristic making it very difficult to obtain a fine control.

The invention will be described in the following in connection to shown embodiments, where;

FIG. 1 shows the variation of the pressure drop according to the angle of rotation v at a conventional throttling means.

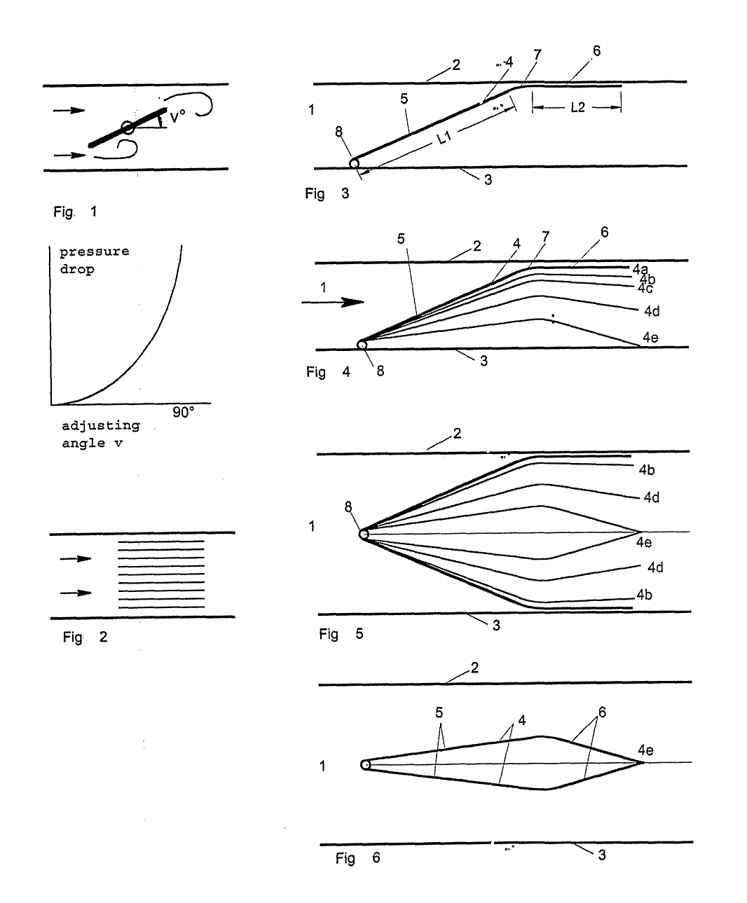

FIG. 2 shows throttling means creating a pressure drop by friction losses in a number of parallel channels having a small cross section area resulting in a laminar flow with a high friction coefficient,

FIGS. 3, 4 and 5 are examples of different embodiments of throttling devices according to the invention,

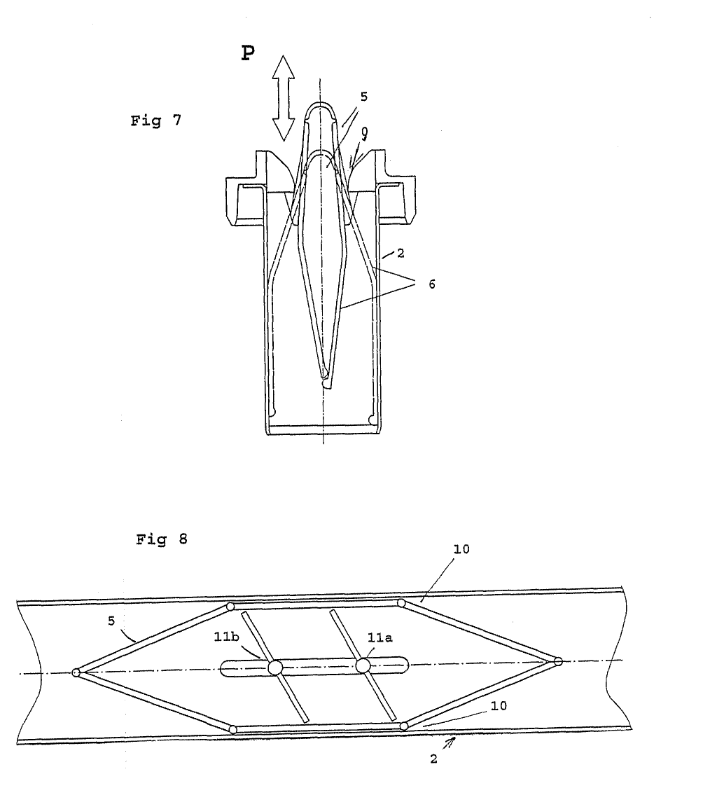

FIG. 6 shows an embodiment of the throttling device according to FIG. 5, now with the throttling blades in a maximal open position.

FIG. 7 shows three different variants of a throttling device according to the invention in where an axial displacement will perform an adjustment by cooperation with radial projections in the channel, and where

FIG. 8 shows a throttling device according to the invention in the shape of an expandable body being influenced from the inside in connection to a control of the throttling of the channel.

FIG. 1 having two parts and showing above a central journal led conventional throttling device set in an angular position v. In the diagram according to FIG. 1 the variation of the pressure drop is show according to the rotational angle of the throttling device.

In FIG. 2 an other known throttling device is shown having several flow channels with small cross sectional areas causing a laminar flow with a high friction coefficient.

FIG. 3 shows an embodiment having a damper blade 4 rotatable around a shaft 8 attached to the lower wall 3 in a channel 1 having a rectangular cross section and to the two opposing walls 2 and 3. The damper blade 4 have a flat portion 6 with the length L2 and a portion 5 with the length L1, also flat, but which also may be convex out towards the oncoming flow direction. The portions 5 and 6 of the damper blade are interconnected by a rounded portion 7.

The geometry of the damper blade is such that the end portion 6 of the damper blade at a closed position is parallel to the channel wall 2.

FIG. 4 disclose the same embodiment as FIG. 3 but here with the damper blade 4 in alternative opening positions, 4a (closed)-4e (completely open). In the positions of the damper blades with a high pressure drop (4a-4c) constitutes the damper blade portion 6 together with the channel wall 2 a flowing space having a small height making the flow mainly laminar with a high pressure drop and consequently a low noise level.

In a more open position (4d-4e) the flow has been transformed to be more turbulent but here the velocity and the pressure drop are so low that the noise level still is low.

FIG. 5 discloses an embodiment having double damper blades 4 journal led around an axis 8 in the channel in the middle of the channel 1 and where the blades, by a here not disclosed mechanics is rotated around the shaft 8 in an opposite rotation with the same angle so that the channel is divided in two equally large openings

FIG. 6 discloses the same embodiment as in FIG. 5, but with the damper blade 4 in a maximal channel opening position 4e. As is disclosed of FIG. 6 the above described shape of the damper blade 4 a continuous decreasing cross section flowing area between the channel walls 2, 3 and the forward portions 5 of the damper blades performing a close lossless accelerating flow to be followed by an outlet expanding channel portion between the channel walls 2, 3 and the rear portions 6 of the damper blades giving a low risk for relieve of the flow and with a low pressure drop.

In FIG. 7 different embodiments of the damper blade of the throttling device are shown, and which device here is shown axially displaceable to its channel to perform an adjustment. The damper blades 6 are flexible and so designed that they in a maximal throttled position are close to and parallel to the inner channel wall. The rounded ribs at the normally down stream ends of the damper blades have a possibility to also allow a reverse flow in the channel, in which the ribs will contribute to form a silent laminar flow at the inflow into the channel opening gap between the damper blade and the channel wall at a reverse flow. This may be beneficial in certain circumstances.

The embodiment according to FIG. 8 shows yet an other example of a throttling device according to the invention in the shape of an expandable body being activated from the inside in connection to adjustment of the throttling of the channel. Here two rotation means have been shown as activating means to adjust the throttling of the channel. The activating means may also be of a pneumatic or hydraulic type.

The above described damper blade embodiments may also be used in a channel having a flat-oval cross section if the edges of the damper blades are shaped to connect to the rounded wall portions of the channel in a closed position.

The invention is not restricted to the above described embodiments of the invention but modifications can be done within the scoop of the following claims.

1. Method to control an air flow in a channel (1) or in a channel system, characterized in that the air flow is brought to pass at least a first channel portion having a successively tapering channel cross section area being formed by a adjustable throttling device (4) in the channel, that the air thereafter is led to an other channel portion having a cross section with an increased throttling formed by the adjustable throttling device, to continue flowing in the channel portion with the increased throttling over a distance being considerably longer than the distance between the outer wall of the throttling device and the inner wall of the of the channel portion to thereafter leave the second channel portion with the increased throttling at a third channel portion and be transferred into the not throttled channel.

2. Method according to claim 1, characterized in that the air flow in the third channel portion takes place over a successively increasing cross section area

3. Method according to claim 1, characterized in that the air flow is brought to pass over several adjustable throttling devices and so also over channel portions existing in a channel system including several branch channels.

4. Method according to claim 1, characterized in that the adjustment of the throttling device takes place by an axial displacement of the same, whereby an action from radial, stationary projections (9) in the channel will perform an pressure action inwards on the outsides (6) of the throttling device in such a way that the throttling device will open and allow an increased channel flow through.

5. Method according to claim 1, characterized in that the adjustment of the throttling device takes place by rotating at least two mutually separated leaf dampers within the throttling device and expanding an envelope at the throttling device to decrease the flow through area, or alternatively, are rotated in the opposite direction and allow an inherent elasticity of the envelope decreasing the envelope and thus increasing the flow through area in the channel.

6. Throttling device to control the flow in a channel (1) and to perform the method according to claim 1, characterized in a flat or somewhat convex forward portion (5) and a rear portion (6) being substantially parallel with the inner wall (2, 3) of the channel at a closed or near closed position (4a-4c), whereby the rear portion of the throttling device will extend a substantial distance along the channel wall.

7. Throttling device according to claim 6 and including two opposite damper blades (4) rotatably journal led around a shaft (8) in the middle of the channel (1), characterized in that each damper blade (4) is made with a flat or somewhat convex forward portion (5) and a rearward flat portion (6) forming such an angle to each other that the rear portions (6) of the damper blades (4) at a closed or near closed position (4a-4e) are parallel or near parallel to the channel walls (2, 3).

8. Throttling device according to claim 6, characterized in that the length (L1) of the forward portion (5) of the damper blade is bigger than the length (L2) of the rear portion (6) of the damper blade, i.e. L1>L2.

9. Throttling device according to claim 6, characterized in that the normally rear ends of the damper blades have a rounded edge.

10. Throttling device according to claim 6, characterized in that is consists of an expandable and dynamically form stable body, which from an open position is arranged to be set under pressure and expand to a wanted shape in the channel to throttle said channel.

11. Throttling device according to claim 6, characterized in that the normally rear ends of the damper blades have a rounded edge.

12. Throttling device according to claim 8, characterized in that the normally rear ends of the damper blades have a rounded edge.

13. Method according to claim 2, characterized in that the adjustment of the throttling device takes place by an axial displacement of the same, whereby an action from radial, stationary projections (9) in the channel will perform an pressure action inwards on the outsides (6) of the throttling device in such a way that the throttling device will open and allow an increased channel flow through.

14. Method according to claim 3, characterized in that the adjustment of the throttling device takes place by an axial displacement of the same, whereby an action from radial, stationary projections (9) in the channel will perform an pressure action inwards on the outsides (6) of the throttling device in such a way that the throttling device will open and allow an increased channel flow through.

15. Method according to claim 2, characterized in that the adjustment of the throttling device takes place by rotating at least two mutually separated leaf dampers within the throttling device and expanding an envelope at the throttling device to decrease the flow through area, or alternatively, are rotated in the opposite direction and allow an inherent elasticity of the envelope decreasing the envelope and thus increasing the flow through area in the channel.

16. Method according to claim 3, characterized in that the adjustment of the throttling device takes place by rotating at least two mutually separated leaf dampers within the throttling device and expanding an envelope at the throttling device to decrease the flow through area, or alternatively, are rotated in the opposite direction and allow an inherent elasticity of the envelope decreasing the envelope and thus increasing the flow through area in the channel.
